(19) United States
(12) Patent Application Publication
(10) Pub. No.: US 2007/0247880 A1
(43) Pub. Date: Oct. 25, 2007

(54) FULL-BRIDGE ACTIVE CLAMP DC-DC CONVERTER

(75) Inventors: Bong Hwan KWON, Pohang-city (KR); Jung Min KWON, Pohang-city (KR)

Correspondence Address: ROTHWELL, FIGG, ERNST & MANBECK, P.C., 1425 K STREET, N.W., SUITE 800, WASHINGTON, DC, 20005, US

(73) Assignees: POSTECH FOUNDATION, Pohang-city (KR); POSTECH ACADEMY-INDUSTRY FOUNDATION, Pohang-city (KR)

(21) Appl. No.: 11/466,841

(22) Filed: Aug. 24, 2006

(30) Foreign Application Priority Data
Apr. 19, 2006 (KR) 10-2006-0035323

(51) Int. Cl. H02J 1/00

(52) U.S. Cl. 363/56.02; 363/15

(57) ABSTRACT

Provided is a full-bridge active clamp DC-DC converter for reducing power loss due to high-speed switching by primary switches that are zero-voltage switched by energy stored as a leakage inductance of a transformer when main switches are on or off using a full-bridge active clamp circuit, which can be used at capacity, e.g., more than 1 KW. The full-bridge active clamp DC-DC converter includes a primary circuit and a secondary circuit divided by a transformer, the primary circuit, which is a full-bridge active clamp circuit, comprising an input capacitor C_{d}, two main switches S₁ and S₂, two sub-switches S₃ and S₄, and a clamp capacitor C_{c}, and the secondary circuit, which is an output rectification circuit for rectifying an output voltage.

### CROSS-REFERENCE TO RELATED PATENT APPLICATION

This application claims the benefit of Korean Patent Application No. 10-2006-0035323, filed on Apr. 19, 2006, in the Korean Intellectual Property Office, the disclosure of which is incorporated herein in its entirety by reference.

### BACKGROUND OF THE INVENTION

1. Field of the Invention

The present invention relates to a full-bridge active clamp DC-DC converter, and more particularly, to a full-bridge active clamp DC-DC converter for reducing power loss due to high-speed switching by primary switches that are zero-voltage switched by energy stored as a leakage inductance of a transformer when main switches are on or off using a full-bridge active clamp circuit, which can be used at capacity, e.g., more than 1 KW.

The present invention also relates to a full-bridge active clamp DC-DC converter in which switches having a lower internal voltage than the maximum input voltage can be used by lowering a voltage stress of the switches lower than the maximum input voltage.

2. Description of the Related Art

Conventional switching converters, such as flyback converters and forward converters, which are well known to those of ordinary skill in the art, use an active clamp circuit to form a discharge path of energy stored as a leakage inductance or a magnetizing inductance in a switching operation. For example, an active clamp circuit including a single sub-switch and a single capacitor is activated when a main switch is off, preventing a switching component from being damaged due to energy stored as a leakage inductance or a magnetizing inductance, and reuses the energy, thereby increasing power conversion efficiency.

However, in conventional switching converters, since voltage stress of a switch is higher than the maximum input voltage, a switch having a higher internal voltage than the maximum input voltage must be used, and thus power increase is limited.

### SUMMARY OF THE INVENTION

The present invention provides a full-bridge active clamp DC-DC converter for reducing power loss due to high-speed switching by primary switches that are zero-voltage switched by energy stored as a leakage inductance of a transformer when main switches are on or off using a full-bridge active clamp circuit, which can be used at capacity, e.g., more than 1 KW.

The present invention also provides a full-bridge active clamp DC-DC converter in which switches having a lower internal voltage than the maximum input voltage can be used by lowering a voltage stress of the switches lower than the maximum input voltage.

According to an aspect of the present invention, there is provided a full-bridge active clamp DC-DC converter comprising a primary circuit and a secondary circuit divided by a transformer, the primary circuit, which is a full-bridge active clamp circuit, comprising an input capacitor C_{d}, two main switches S₁ and S₂, two sub-switches S₃ and S₄, and a clamp capacitor C_{c}, and the secondary circuit, which is an output rectification circuit for rectifying an output voltage.

A voltage V_{c} applied to the clamp capacitor C_{c} may be lower than the maximum input voltage.

The clamp capacitor C_{c} may be connected to drains of the switches S₁ and S₄.

The output rectification circuit may be a full-wave series-resonant circuit comprising two diodes D₁ and D₂ commonly connected to one end of the secondary winding of the transformer and series-resonant capacitors C₁ and C₂ commonly connected to the other end of the secondary winding of the transformer.

The output rectification circuit may be a diode rectification current-doubler circuit comprising two diodes and two inductors, which are connected to the secondary winding of the transformer.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram of a full-bridge active clamp DC-DC converter according to an embodiment of the present invention;

FIG. 2A is a circuit diagram of a full-bridge active clamp DC-DC converter according to another embodiment of the present invention;

FIG. 2B is a circuit diagram of a full-bridge active clamp DC-DC converter according to another embodiment of the present invention;

FIG. 3A is an equivalent circuit diagram of an electronic wave output series-resonant circuit when main switches illustrated in FIG. 2A are on;

FIG. 3B is an equivalent circuit diagram of the full-wave series-resonant circuit when main switches illustrated in FIG. 2A are off; and

FIG. 4 illustrates waveform diagrams showing an operation of the full-bridge active clamp DC-DC converter illustrated in FIG. 2A.

### DETAILED DESCRIPTION OF THE INVENTION

The present invention will now be described more fully with reference to the accompanying drawings, in which exemplary embodiments of the invention are shown. In the following description, well-known functions or constructions are not described in detail since they would obscure the invention in unnecessary detail. However, the terminology described below is defined considering functions in the present invention and may vary according to a user or manner of application. Thus, the definitions should be understood based on all the contents of the specification.

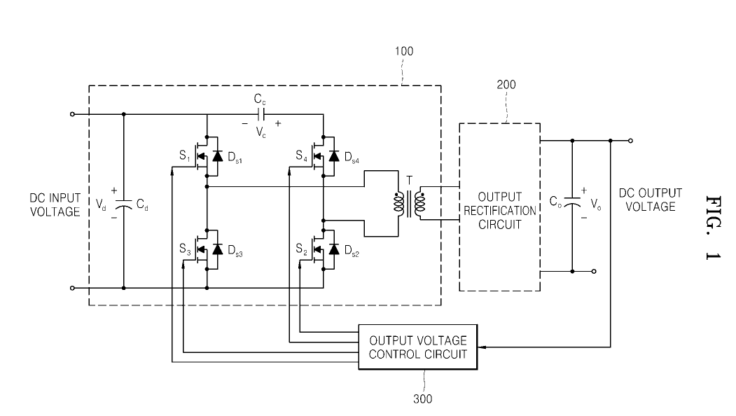

FIG. 1 is a circuit diagram of a full-bridge active clamp DC-DC converter according to an embodiment of the present invention.

Referring to FIG. 1, the full-bridge active clamp DC-DC converter includes a full-bridge active clamp circuit 100 on the primary side of a transformer T and an output rectification circuit 200 on a secondary side of the transformer T. The full-bridge active clamp circuit 100 includes an input capacitor C_{d}, two main switches S₁ and S₂, two sub-switches S₃ and S₄, where S₁, S₂, S₃ and S₄ may be metal oxide semiconductor field effect transistors (MOSFETs), a clamp capacitor C_{c}, and the transformer T. The full-bridge active clamp circuit 100 prevents a switching component from being damaged due to energy stored as a leakage inductance or a magnetizing inductance of the transformer T and reuses the energy, thereby increasing power conversion efficiency. In addition, since a voltage V_{c} applied to the clamp capacitor C_{c} is lower than the maximum input voltage, voltage stresses on the switches are low.

Although the clamp capacitor C_{c} is connected to drains of the switches S₁ and S₄ in FIG. 1, the same operation is possible by connecting the clamp capacitor C_{c} to the drain of the switch S₄ and a negative terminal of a DC input voltage source supplying voltage V_{d}.

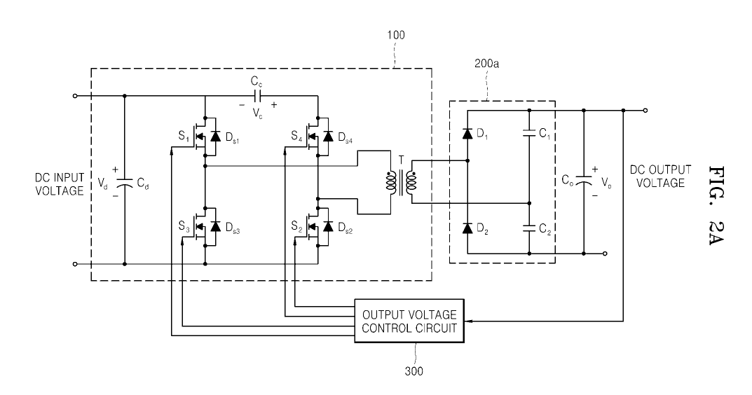

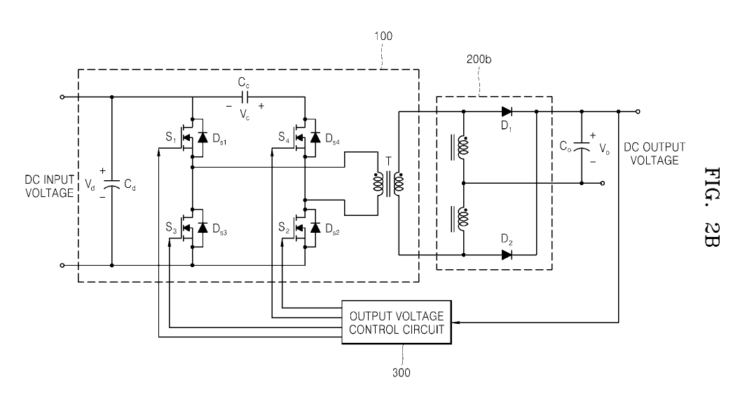

FIG. 2A is a circuit diagram of a full-bridge active clamp DC-DC converter according to another embodiment of the present invention. Referring to FIG. 2A, the output rectification circuit 200 of FIG. 1 is implemented by a full-wave series-resonant circuit 200a. When the full-wave series-resonant circuit 200a is used in the full-bridge active clamp DC-DC converter according to an embodiment of the present invention, the full-bridge active clamp circuit 100 provides a path through which the energy stored as the leakage inductance of the transformer T can be transferred and reused. The full-wave series-resonant circuit 200a includes diodes D₁ and D₂ and series-resonant capacitors C₁ and C₂ and is electrically isolated from the full-bridge active clamp circuit 100 by the transformer T.

An output voltage Vₒ of the full-bridge active clamp DC-DC converter according to an embodiment of the present invention is adjusted by adjusting duty ratios (ratio of a conduction time to a switching time) of the main switches S₁ and S₂ by being fed back to an output voltage control circuit 300 well known to those of ordinary skill in the art.

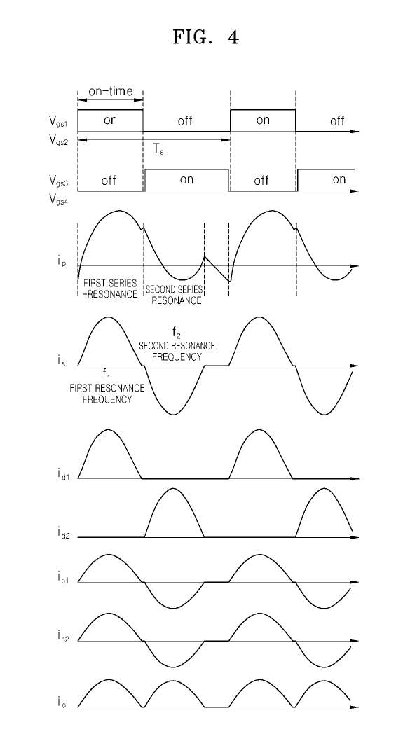

The main switches S₁ and S₂ and the sub-switches S₃ and S₄, which may be implemented by MOSFETs, complementarily operate during a predetermined switching time Tₛ as illustrated in FIG. 4 (asymmetrical pulse width modulation (PWM) method). When the main switches S₁ and S₂ are on, the leakage inductance of the transformer T and the series-resonant capacitors C₁ and C₂ are series-resonant, thereby transferring energy to the secondary side of the transformer T. Even when the main switches S₁ and S₂ are off, a path is formed due to an on-state of the sub-switches S₃ and S₄, and thereby the leakage inductance of the transformer T and the series-resonant capacitors C₁ and C₂ are series-resonant in the same manner as when the main switches S₁ and S₂ are on. Thus, the switches in the primary side of the transformer T are zero-voltage switched due to the energy stored as the leakage inductance of the transformer T, thereby reducing power loss due to high-speed switching. The two diodes on the secondary side of the transformer T, i.e., the diodes D₁ and D₂ of the full-wave series-resonant circuit 200a, are zero-current switched due to series-resonance generated when a switch is on or off, thereby removing power loss due to a reverse recovery characteristic of diodes.

Since a sinusoidal current waveform generated due to series-resonance generated when the main switches S₁ and S₂ are on and series-resonance generated when the main switches S₁ and S₂ are off becomes a full-wave current waveform having a peak current lower than a current flowing through the secondary side of the transformer T by the series-resonant capacitors C₁ and C₂ of the full-wave series-resonant circuit 200a on the secondary side of the transformer T, it is advantageous in a ripple characteristic and capacity of an output capacitor Cₒ.

If one capacitor is removed from the full-wave series-resonant circuit 200a illustrated in FIG. 2A, i.e., if C₁=0 or C₂=0, the full-wave series-resonant circuit 200a becomes a half-wave output series-resonant circuit, transferring a half-wave current waveform to the output capacitor Cₒ, thereby increasing ripple of the output voltage Vₒ.

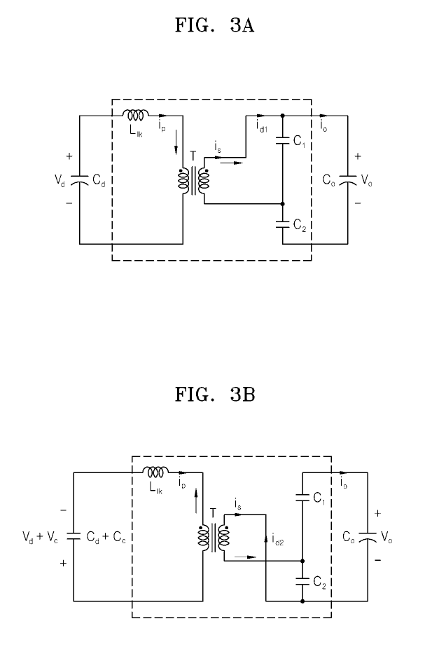

FIGS. 3A and 3B are equivalent circuit diagrams of the full-bridge active clamp DC-DC converter having the full-wave series-resonant circuit 200a when the switches illustrated in FIG. 2A are on or off. That is, FIG. 3A is a first series-resonant equivalent circuit formed by the series-resonant capacitors C₁ and C₂ according to the leakage inductance of the transformer T and a winding ratio of the transformer T when the main switches S₁ and S₂ are on, and FIG. 3B is a second series-resonant equivalent circuit formed by the series-resonant capacitors C₁ and C₂ according to the leakage inductance of the transformer T, the clamp capacitor C_{c}, and the winding ratio of the transformer T when the main switches S₁ and S₂ are off.

FIG. 4 illustrates waveform diagrams showing an operation of the full-bridge active clamp DC-DC converter having the full-wave series-resonant circuit 200a illustrated in FIG. 2A.

Referring to FIGS. 3A, 3B, and 4, the main switches S₁ and S₂ and the sub-switches S₃ and S₄ form pairs, respectively, and operate complementarily. A primary current iₚ and a secondary current iₛ of the transformer T generate a resonance current waveform having a first resonance frequency f₁ by using the first series-resonant equivalent circuit illustrated in FIG. 3A when the main switches S₁ and S₂ are on. When main switches S₁ and S₂ are off, the sub-switches S₃ and S₄ are on, and the primary current iₚ and the secondary current iₛ of the transformer T generate another resonance current waveform having a second resonance frequency f₂ by using the second series-resonant equivalent circuit illustrated in FIG. 3B. A current waveform on the primary side of the transformer T, which is generated by the first and second resonance frequencies f₁ and f₂, makes the switches zero-voltage switched. A sine wave current waveform in the secondary side of the transformer T, which is generated by the first and second resonance frequencies f₁ and f₂, makes the diodes D₁ and D₂ zero-current switching, thereby reducing power loss due to reverse recovery of the diodes D₁ and D₂. An output current iₒ becomes a full-wave rectified current waveform due to a current flowing through the diodes D₁ and D₂ and the series-resonant capacitors C₁ and C₂. In another embodiment, when an equivalent circuit including only one of the series-resonant capacitors C₁ and C₂ is formed, since a current flowing through the diode D₁ or D₂ flows through the output capacitor Cₒ without changing, a half-wave rectified current waveform having a relatively higher peak current compared to the full-wave rectified current waveform can be obtained. This can be called a half-wave output series-resonant circuit, increasing voltage ripples of the output capacitor Cₒ compared to the full-wave series-resonant circuit 200a.

In FIG. 4, V_{gs1} and V_{gs2} denote gate driving signals of the main switches S₁ and S₂, respectively, V_{gs3} and V_{gs4} denote gate driving signals of the sub-switches S₃ and S₄, respectively, and i_{c1} and i_{c2} denote currents flowing through the series-resonant capacitors C₁ and C₂, respectively.

FIG. 2B is a circuit diagram of a full-bridge active clamp DC-DC converter according to another embodiment of the present invention. Referring to FIG. 2B, the output rectification circuit 200 of FIG. 1 is implemented by a diode rectification current-doubler circuit 200b.

The configuration of FIG. 2B is the same as the configuration of FIG. 2A except that the full-wave series-resonant circuit 200a is replaced with the diode rectification current-doubler circuit 200b including the diodes D₁ and D₂ and inductors L₁ and L₂. In FIG. 2B, the two inductors L₁ and L₂ can be loosely coupled or can be used independently. A current flowing through the diodes D₁ and D₂ on the secondary side of the transformer T is a square wave, minimizing a peak current of each of the diodes D₁ and D₂ and reducing a turn-on loss of each of the diodes D₁ and D₂, thereby being advantageous for a low-voltage output. The full-bridge active clamp DC-DC converter illustrated in FIG. 2B can use a transformer having an intermediate tap for replacing the two inductors L₁ and L₂

As described above, in a full-bridge active clamp DC-DC converter according to embodiments of the present invention, a power loss due to high-speed switching can be reduced by primary switches zero-voltage switched by energy stored as a leakage inductance of a transformer when main switches are on or off using a full-bridge active clamp circuit, which can be used at capacity, e.g., more than 1 KW.

In addition, switches having a lower internal voltage than the maximum input voltage can be used by lowering a voltage stress of the switches lower than the maximum input voltage.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A full-bridge active clamp DC-DC converter comprising a primary circuit and a secondary circuit divided by a transformer:
the primary circuit, which is a full-bridge active clamp circuit, comprising an input capacitor C_{d}, two main switches S₁ and S₂, two sub-switches S₃ and S₄, and a clamp capacitor C_{c}; and
the secondary circuit, which is an output rectification circuit for rectifying an output voltage.

2. The full-bridge active clamp DC-DC converter of claim 1, wherein a voltage V_{c} applied to the clamp capacitor C_{c} is lower than the maximum input voltage.

3. The full-bridge active clamp DC-DC converter of claim 1, wherein the clamp capacitor C_{c} is connected to drains of the switches S₁ and S₄.

4. The full-bridge active clamp DC-DC converter of claim 1, wherein the output rectification circuit is a full-wave series-resonant circuit comprising two diodes D₁ and D₂ commonly connected to one end of the secondary winding of the transformer and series-resonant capacitors C₁ and C₂ commonly connected to the other end of the secondary winding of the transformer.

5. The full-bridge active clamp DC-DC converter of claim 1, wherein the output rectification circuit is a diode rectification current-doubler circuit comprising two diodes and two inductors, which are connected to the secondary winding of the transformer.

6. The full-bridge active clamp DC-DC converter of claim 5, wherein the two inductors can be replaced with a transformer having an intermediate tap.
